(19) United States
(12) Patent Application Publication
(10) Pub. No.: US 2007/0290422 A1
(43) Pub. Date: Dec. 20, 2007

(54) Electronic apparatus

(75) Inventor: Tamotsu Akashi, Kawasaki (JP)

Correspondence Address: BINGHAM MCCUTCHEN LLP, 2020 K Street, N.W., Intellectual Property Department, WASHINGTON, DC, 20006, US

(73) Assignee: FUJITSU LIMITED

(21) Appl. No.: 11/602,254

(22) Filed: Nov. 21, 2006

(30) Foreign Application Priority Data
Jun. 15, 2006 (JP) 2006-165533

(51) Int. Cl. F16M 1/00

(52) U.S. Cl. 267/136

(57) ABSTRACT

Disclosed is an electronic apparatus having a high-reliability vibration-proof structure for a wide temperature range. The electronic apparatus comprises a casing for storing a hard disk; and a rubber vibration isolator having projections on both faces thereof, which is disposed between the hard disk and the casing such that the projections have contact areas with the hard disk as well as with the casing and in which the contact area and an inverse number of Young's modulus are equal in the change rate caused due to temperature change. Accordingly, a spring constant can be maintained virtually constant without depending on the temperature change.

### CROSS-REFERENCE TO RELATED APPLICATIONS

This application is based upon and claims the benefits of priority from the prior Japanese Patent Application No. 2006-165533, filed on Jun. 15, 2006, the entire contents of which are incorporated herein by reference.

### BACKGROUND OF THE INVENTION

1. Field of the Invention

The present invention relates to an electronic apparatus. More particularly, the present invention relates to an electronic apparatus with a vibration-proof structure for a wide temperature range.

2. Description of the Related Art

In a precision apparatus such as a notebook computer having mounted thereon a portable hard disk, a vibration-proof structure using elastic characteristics of rubber is generally used for a method for preventing external vibrations and shocks on the hard disk. FIG. 15 is a schematic view of a vibration-proof structure of a portable hard disk. As shown in FIG. 15, a hard disk 102 around which a rubber vibration isolator 103 with a rectangular parallelepiped shape is disposed is stored in a casing 101. As in the case of a vibration-proof structure 100 of the portable hard disk, when the rubber vibration isolator 103 is disposed around the hard disk 102, external vibrations and shocks are damped due to the elastic characteristics of rubber. As a result, the hard disk 102 can be stably operated.

Generally, when the vibration-proof structure using rubber is used in a limited temperature range near room temperature, a vibration and shock damping effect due to the elastic characteristics of rubber is obtained as described above. However, when the rubber vibration isolator 103 is used in an environment at a temperature higher or lower than a room temperature, the elastic characteristics of rubber change and therefore, external vibrations and shocks on the hard disk 102 are not sufficiently damped. That is, the elastic characteristics of rubber include temperature dependence. Generally, rubber is hardened at a low temperature and softened at a high temperature. Accordingly, a spring constant of the rubber vibration isolator 103 changes with temperature changes and therefore, a damping factor of the external vibrations and shocks similarly changes.

Consequently, there is proposed a method of compensating a spring constant of a rubber vibration isolator, which changes with temperature changes. Examples of the method include a method of fitting in a rubber vibration isolator a temperature compensation member made of a shape-memory alloy (see, e.g., Japanese Unexamined Patent Application Publication No. Hei 6-96566).

A case of fitting a temperature compensation member in a rubber vibration isolator will be described below.

FIG. 16 is a graph of spring displacement dependence of a spring constant in temperature changes.

When producing displacement 5 on an elastic body with a spring constant k, a force F can be generally represented as in the following formula (1).

F=k×δ (1)

Herein, for example, there will be described a case where a temperature in using a rubber vibration isolator changes from 20 to 60° C. In a rubber vibration isolator with displacement δ₂₀ at 20° C. (point A), when a temperature rises to 60° C., the spring constant decreases (point B) as shown in FIG. 16. Due to rise in temperature, the spring constant of the rubber vibration isolator decreases as well as a shape of a temperature compensation member made of a shape-memory alloy changes. Due to a change in the shape of the temperature compensation member, the rubber vibration isolator is pressurized and compressed by displacement Δδ to cause displacement of the rubber vibration isolator to be displacement δ₆₀. As a result, the spring constant of the rubber vibration isolator increases so that the spring constant at 20° C. can be maintained (point C).

As seen from the above description, when a temperature compensation member is fitted in a rubber vibration isolator, elastic characteristics of the rubber vibration isolator is maintained even in a wide temperature range so that external vibrations and shocks can be damped.

However, this method has the following problems. That is, since a shape change in a shape-memory alloy due to temperature changes is used, additional materials are required. Further, since a special shape-memory alloy is used, the cost increases.

### SUMMARY OF THE INVENTION

In view of the foregoing, it is an object of the present invention to provide an electronic apparatus having a high-reliability vibration-proof structure for a wide temperature range.

To accomplish the above-described object, there is provided an electronic apparatus having an electronic unit with a vibration-proof structure. This electronic apparatus comprises: a casing for storing the electronic unit; and a vibration control body having projections on one face or both faces thereof, which is disposed between the electronic unit and the casing such that the projections have contact areas with the electronic unit as well as with the casing and in which the contact areas and an inverse number of Young's modulus are equal in the change rate caused due to temperature change.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a schematic cross-sectional view of an essential part at room temperature according to the present invention.

FIG. 2 is a schematic cross-sectional view of an essential part at a temperature higher than a room temperature according to the present invention.

FIG. 3 is a graph of a temperature behavior of a visco-elastic material.

FIG. 4 is a schematic cross-sectional view of an essential part at room temperature according to a first embodiment.

FIG. 5 is a schematic cross-sectional view of an essential part at a temperature higher than a room temperature according to a first embodiment.

FIG. 6 is a graph of compression distance dependence of a contact area change rate according to a first embodiment.

FIG. 7 is a schematic cross-sectional view of an essential part at room temperature according to a second embodiment.

FIG. 8 is a schematic cross-sectional view of an essential part at a temperature higher than a room temperature according to a second embodiment.

FIG. 9 is a graph of compression distance dependence of a contact area change rate according to a second embodiment.

FIG. 10 is a schematic oblique view of a rubber vibration isolator having projections linearly arranged.

FIG. 11 is a schematic oblique view of a rubber vibration isolator having projections arranged in the form of points.

FIG. 12 is a schematic cross-sectional view of an essential part of a rubber vibration isolator according to a third embodiment.

FIG. 13 is a graph of temperature dependence of Young's modulus E of silicone rubber in each frequency of external vibrations and shocks.

FIG. 14 is a graph of compression distance dependence of a contact area change rate according to a third embodiment.

FIG. 15 is a schematic view of a vibration-proof structure of a portable hard disk.

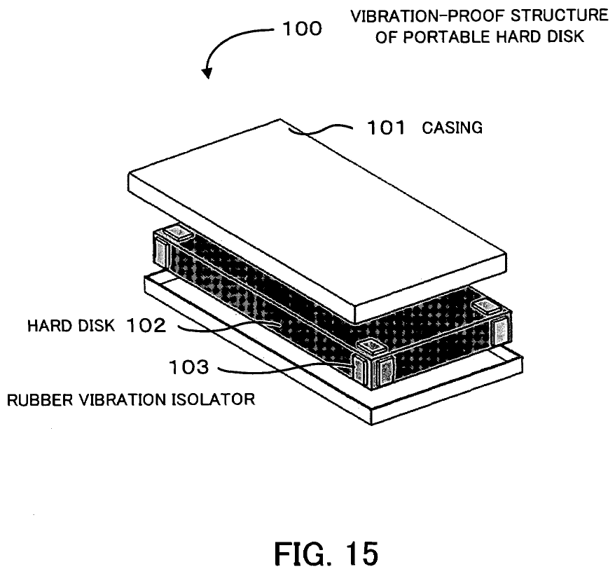

FIG. 16 is a graph of spring displacement dependence of a spring constant in temperature changes.

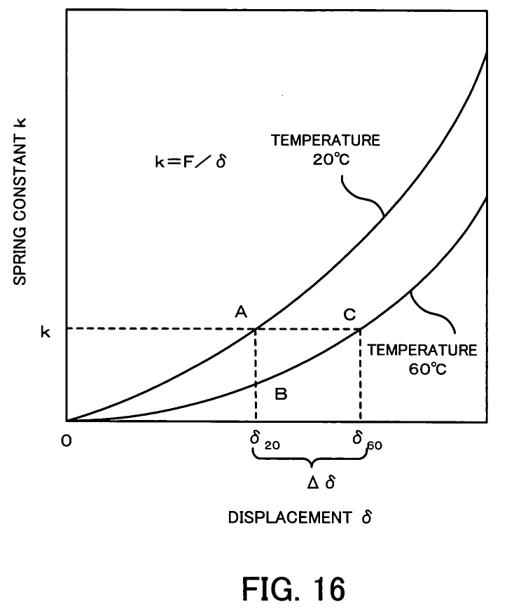

### DESCRIPTION OF THE PREFERRED EMBODIMENTS

Preferred embodiment of the present invention will be described in detail below with reference to the accompanying drawings, wherein like reference numerals refer to like elements throughout.

First, an outline of the present invention will be described below.

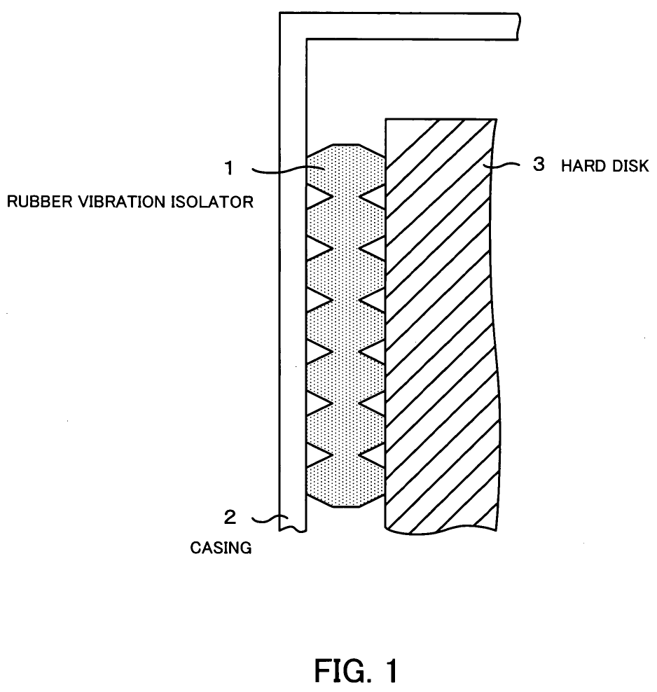

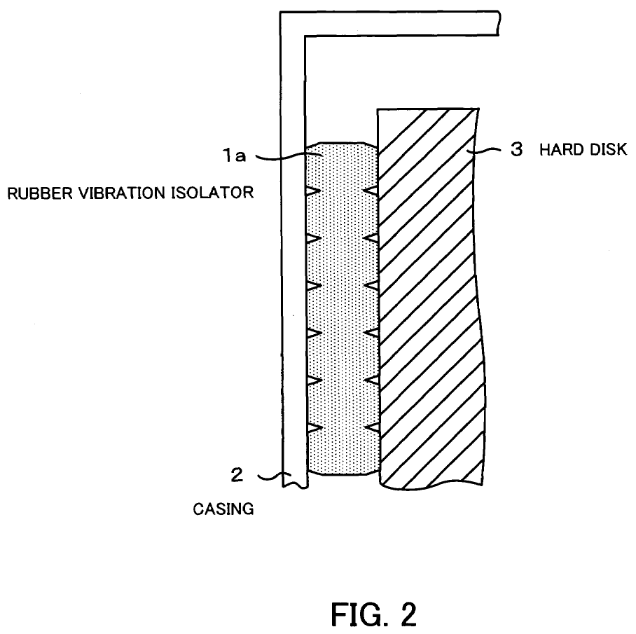

FIG. 1 is a schematic cross-sectional view of an essential part at room temperature according to the present invention. FIG. 2 is a schematic cross-sectional view of an essential part at a temperature higher than a room temperature according to the present invention.

As shown in FIG. 1, a rubber vibration isolator 1 is disposed between a hard disk 3 and a casing 2. Note, however, that a plurality of projections are formed on portions of the isolator 1 which comes into contact with the hard disk 3 and with the casing 2.

The rubber vibration isolator 1 having formed thereon the plurality of projections will be described below.

A contact area between the projection of the isolator 1 and the hard disk 3 as well as between the projection and the casing 2 is represented by S, and a thickness of the isolator 1 is represented by d.

At this time, a spring constant k of the rubber vibration isolator 1 can be represented as in the following formula (2) using Young's modulus E of the isolator 1.

k=E×(S/d) (2)

In this rubber vibration isolator 1, a change in characteristics such as the spring constant k and the Young's modulus E is caused by the temperature in the use environment. Therefore, a condition represented by the following formula (3) is set in formula (2).

Δ(S/d)=Δ(1/E) (3)

That is, although the temperature dependence of the Young's modulus E depends on materials of the rubber vibration isolator 1, when a shape of the isolator 1 is formed to satisfy the formula (3), the spring constant k can be maintained virtually constant even if the temperature in the use environment changes.

Therefore, in the present invention, the projections of the isolator 1 are formed as shown in FIG. 1. Therefore, for example, when the temperature in the use environment changes to a temperature higher than a room temperature in FIG. 1, the contact area S between the projection of the isolator 1a and the hard disk 3 as well as between the projection and the casing 2 increases due to a thermal expansion coefficient of the isolator 1a as shown in FIG. 2. Further, the contact area S and an inverse number of Young's modulus E are made equal in the change rate caused due to temperature change, in order to satisfy the formula (3). As a result, the spring constant k can be maintained virtually constant even if the temperature in the use environment changes.

As described above, in the present invention, the rubber vibration isolators 1 and 1a have projections. Therefore, the contact area S between the projection and the hard disk 3 as well as between the projection and the casing 2 can change depending on the temperature changes in the use environment. Further, the contact area S and an inverse number of Young's modulus E of the isolators 1 and 1a are made equal in the change rate caused due to temperature change. Therefore, the spring constant k of the isolators 1 and 1a can be maintained virtually constant even if the temperature in the use environment changes. As a result, a high-reliability vibration-proof structure for a wide temperature range can be obtained.

In the present invention, the outline is described by taking as an example a case where the temperature in the use environment changes to a temperature higher than a room temperature. Further, even when the temperature in the use environment changes to a temperature lower than a room temperature, the same effect can be obtained.

When the hard disk 3 and the casing 2 are made of metals, a change rate caused due to temperature change in a space between the casing 2 and the hard disk 3, in which the rubber vibration isolators 1 and 1a are disposed, has little influence on the present invention even if ignored. The reason is that a thermal expansion coefficient of the metal is smaller than that of the isolator 1 by one to two digit order.

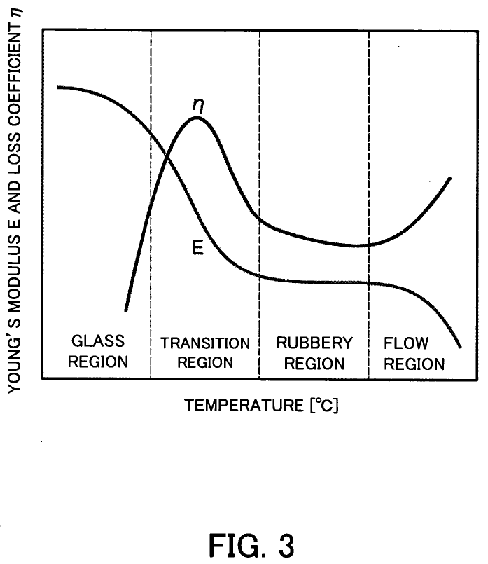

Particularly suitable materials for the rubber vibration isolators 1 and 1a include silicone rubber (silicone gel), urethane rubber (urethane gel) and ethylene propylene rubber, which are commercially-available as vibration-proof materials. In these materials, molecular arrangement is formed such that in order to elevate a damping factor of external vibrations and shocks, a region having a large loss coefficient q is formed near the center of the operating temperature limit. In addition to the above-described materials, other materials can be formed as materials for the rubber vibration isolators 1 and 1a as long as capable of providing the same effect as that of the present invention. FIG. 3 is a graph of a temperature behavior of a visco-elastic material. As shown in FIG. 3, in a region having a large loss coefficient η, the change rate of Young's modulus E due to temperature change is also large and therefore, the effect of the present invention can be particularly effectively exerted.

In the present invention, there is described a case of using a hard disk as an electronic unit. Even in a case of using a precision apparatus which requires vibration isolation, such as an optical communication module unit, the same effect can be obtained. Examples of the optical communication module unit which requires vibration isolation include an optical switch using Micro Electro Mechanical Systems (MEMS). The optical switch is a switch in which a micromirror with a size of 1 mm or less is electrically driven to switch a direction for reflecting light and to switch an optical connection path. In this case, the movable mirror is easily affected by external vibrations and shocks. Therefore, the vibration isolation is required.

Next, a first embodiment will be described.

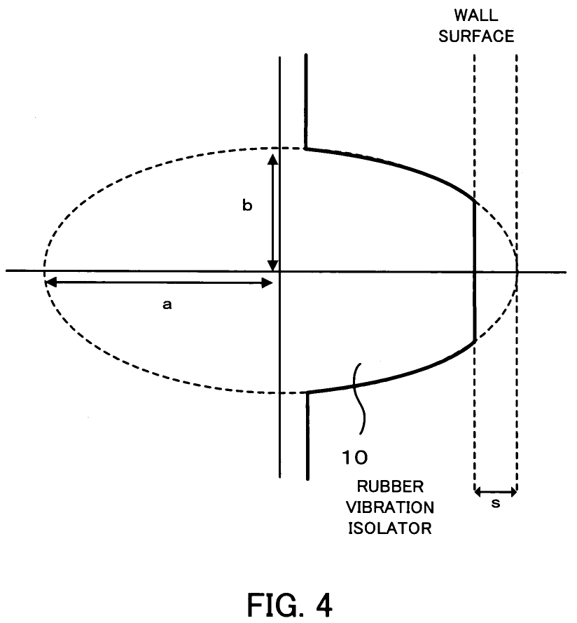

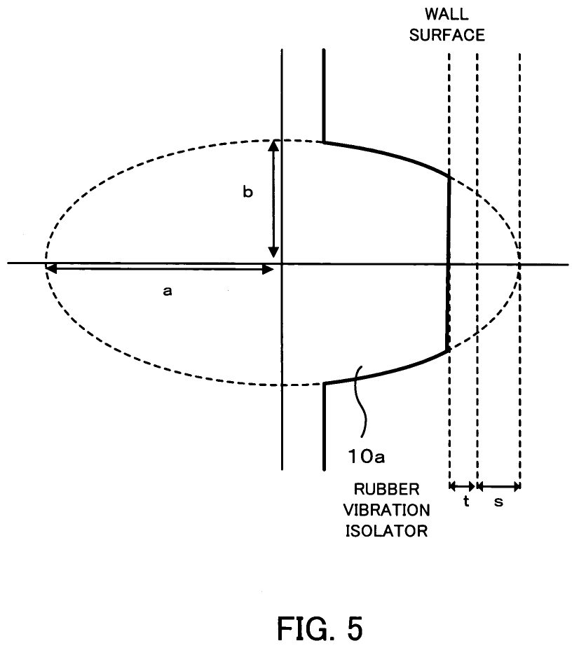

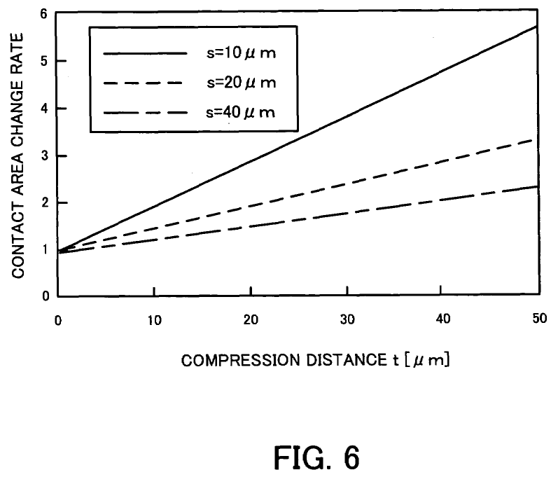

FIG. 4 is a schematic cross-sectional view of an essential part at room temperature according to the first embodiment. FIG. 5 is a schematic cross-sectional view of an essential part at a temperature higher than a room temperature according to the first embodiment. FIG. 6 is a graph of compression distance dependence of a contact area change rate according to the first embodiment.

In the first embodiment, a description will be made by taking as an example the following case. That is, each projection of rubber vibration isolators 10 and 10a has a shape of a part of an ellipsoid as shown in FIGS. 4 and 5. Further, each of the isolators 10 and 10a is disposed between a hard disk and a casing (not shown). Herein, a long side length of the ellipsoid is represented by a, a short side length thereof is represented by b, and a circular constant is represented by n.

First, a state of the rubber vibration isolator 10 at room temperature is as follows. That is, the isolator 10 is compressed such that a compression distance is s as shown in FIG. 4. A contact area Sₑₗ at this time can be represented as in the following formula (4).

Sₑₗ=π(b/a)²×s×(2a−s) (4)

Further, a state of the rubber vibration isolator 10a at a temperature higher than a room temperature is as follows. That is, the isolator 10a is compressed such that a compression distance is s+t as shown in FIG. 5. A contact area Sₑₕ at this time can be represented as in the following formula (5).

Sₑₕ=π(b/a)²×(s+t)×(2a−s−t) (5)

Herein, the long side length a and the short side length b are set, for example, to 2 mm and 1 mm, respectively. Then, the contact area change rate (Sₑₕ/Sₑₗ) is calculated in each case where the contact area s is 10, 20 and 40 μm. Further, results of the calculations are graphed in FIG. 6. From FIG. 6, the compression amount of the rubber vibration isolators 10 and 10a can be read out.

There will be described, for example, a case where the rubber vibration isolator 10 is compressed by 40 μm and deformed to the rubber vibration isolator 10a in the operating temperature limit. When the change rate of Young's modulus E of the rubber vibration isolators 10 and 10a is about one fifth, the compression distance s is set to 10 μm so as to obtain about five times the contact area change rate. Thus, the spring constant k can be maintained virtually constant. Likewise, when the change rate of Young's modulus E is about one third, the compression distance s may be set to 20 μm so as to obtain about three times the contact area change rate. Further, when the change rate of Young's modulus E is about one-half, the compression distance s may be set to 40 μm so as to obtain about twice the contact area change rate.

In the first embodiment, a description is made by taking as an example a case where each projection of the rubber vibration isolators 10 and 10a has a shape of a part of an ellipsoid. In a case where each projection of the rubber vibration isolators 10 and 10a has a shape of a hemisphere, when the long side length a is made equal to the short side length b, the formulae (4) and (5) can be directly used.

As described above, in the first embodiment, the rubber vibration isolators 10 and 10a have projections. Therefore, the contact area between the projection and the hard disk as well as between the projection and the casing can change depending on the temperature changes in the use environment. Further, the contact area and an inverse number of Young's modulus E of the isolators 10 and 10a are made equal in the change rate caused due to temperature change. Therefore, the spring constant k of the isolators 10 and 10a can be maintained virtually constant even if the temperature in the use environment changes. As a result, a high-reliability vibration-proof structure for a wide temperature range can be obtained.

In the first embodiment, a description is made by taking as an example a case where the temperature in the use environment changes to a temperature higher than a room temperature. Further, even when the temperature in the use environment changes to a temperature lower than a room temperature, the same effect can be obtained.

When the hard disk and the casing are made of metals, a change rate caused due to temperature change in a space between the casing and the hard disk, in which the rubber vibration isolators 10 and 10a are disposed, has little influence on the first embodiment even if ignored. The reason is that a thermal expansion coefficient of the metal is smaller than that of the isolators 10 and 10a by one to two digit order.

Particularly suitable materials for the rubber vibration isolators 10 and 10a include silicone rubber (silicone gel), urethane rubber (urethane gel) and ethylene propylene rubber, which are commercially-available as vibration-proof materials. In these materials, molecular arrangement is formed such that in order to elevate a damping factor of external vibrations and shocks, a region having a large loss coefficient q is formed near the center of the operating temperature limit. In addition to the above-described materials, other materials can be formed as materials for the rubber vibration isolators 10 and 10a as long as capable of providing the same effect as that of the first embodiment. As shown in FIG. 3, in a region having a large loss coefficient η, the change rate of Young's modulus E due to temperature change is also large and therefore, the effect of the first embodiment can be particularly effectively exerted.

In the first embodiment, there is described a case of using a hard disk as an electronic unit. Even in a case of using an optical communication module unit, the same effect can be obtained.

Next, a second embodiment will be described.

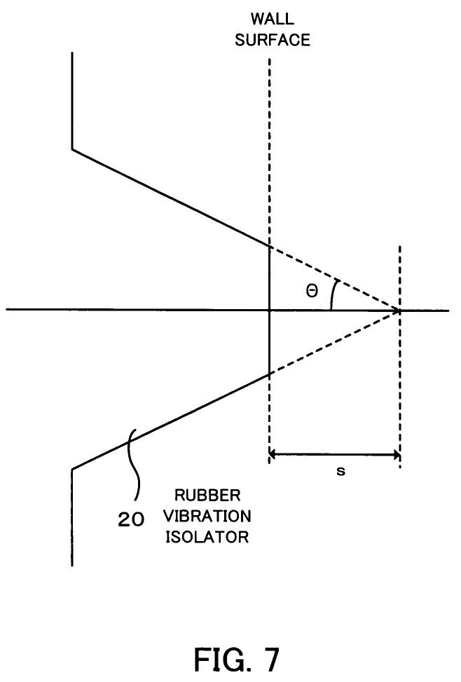

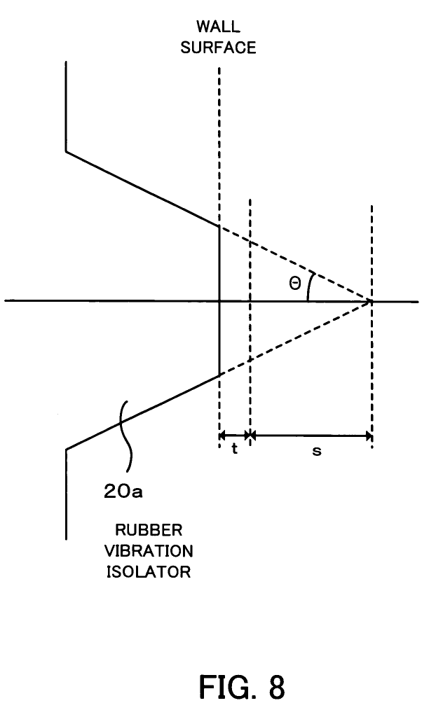

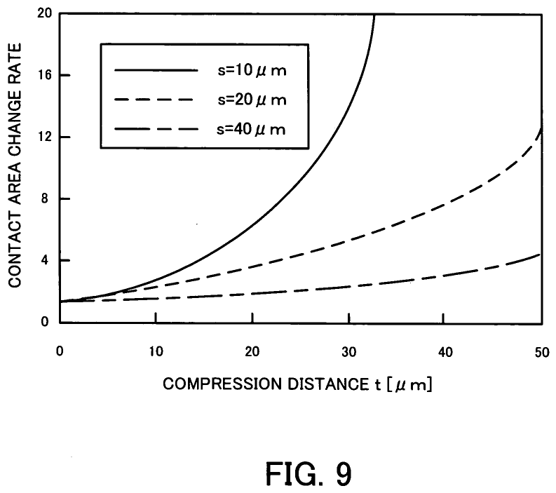

FIG. 7 is a schematic cross-sectional view of an essential part at room temperature according to the second embodiment. FIG. 8 is a schematic cross-sectional view of an essential part at a temperature higher than a room temperature according to the second embodiment. FIG. 9 is a graph of compression distance dependence of a contact area change rate according to the second embodiment.

In the second embodiment, a description will be made by taking as an example the following case. That is, each projection of rubber vibration isolators 20 and 20a has a shape different from that of the first embodiment and is a conical shape of which the leading portion is cut off. Further, each of the isolators 20 and 20a is disposed between a hard disk and a casing (not shown). Herein, an angle in a peak of the conical shape is represented by 2θ and a circular constant is represented by n.

First, a state of the rubber vibration isolator 20 at room temperature is as follows. That is, the isolator 20 is compressed such that a compression distance is s as shown in FIG. 7. A contact area S_{cl} at this time can be represented as in the following formula (6).

S_{cl}=π×s²×tan² θ (6)

Further, a state of the rubber vibration isolator 20a at a temperature higher than a room temperature is as follows. That is, the isolator 20a is compressed such that a compression distance is s+t as shown in FIG. 8. A contact area S_{ch} at this time can be represented as in the following formula (7).

S_{ch}=π×(s+t)²×tan² θ (7)

Herein, the angle θ is set, for example, to 30°. Then, the contact area change rate (S_{ch}/S_{cl}) is calculated in each case where the contact area s is 10, 20 and 40 μm. Further, results of the calculations are graphed in FIG. 9. From FIG. 9, the compression amount of the rubber vibration isolators 20 and 20a can be read out. As a result, in the same manner as in the first embodiment, a compression distance can be determined depending on the change rate of Young's modulus E. As compared with the rubber vibration isolators 10 and 10a in the first embodiment, the rubber vibration isolators 20 and 20a in the second embodiment have a large contact area change rate. Therefore, when a change rate of Young's modulus E of a rubber vibration isolator is large, the isolators 20 and 20a are suitable as a rubber vibration isolator.

As described above, in the second embodiment, the rubber vibration isolators 20 and 20a have projections. Therefore, the contact area between the projection and the hard disk as well as between the projection and the casing can change depending on the temperature changes in the use environment. Further, the contact area and an inverse number of Young's modulus E of the isolators 20 and 20a are made equal in the change rate caused due to temperature change. Therefore, the spring constant k of the isolators 20 and 20a can be maintained virtually constant even if the temperature in the use environment changes. As a result, a high-reliability vibration-proof structure for a wide temperature range can be obtained.

In the second embodiment, a description is made by taking as an example a case where the temperature in the use environment changes to a temperature higher than a room temperature. Further, even when the temperature in the use environment changes to a temperature lower than a room temperature, the same effect can be obtained.

When the hard disk and the casing are made of metals, a change rate due to temperature change in a space between the casing and the hard disk, in which the rubber vibration isolators 20 and 20a are disposed, has little influence on the second embodiment even if ignored. The reason is that a thermal expansion coefficient of the metal is smaller than that of the isolators 20 and 20a by one to two digit order.

Particularly suitable materials for the rubber vibration isolators 20 and 20a include silicone rubber (silicone gel), urethane rubber (urethane gel) and ethylene propylene rubber, which are commercially-available as vibration-proof materials. In these materials, molecular arrangement is formed such that in order to elevate a damping factor of external vibrations and shocks, a region having a large loss coefficient η is formed near the center of the operating temperature limit. In addition to the above-described materials, other materials can be formed as materials for the rubber vibration isolators 20 and 20a as long as capable of providing the same effect as that of the second embodiment. As shown in FIG. 3, in a region having a large loss coefficient η, the change rate of Young's modulus E due to temperature change is also large and therefore, the effect of the second embodiment can be particularly effectively exerted.

In the second embodiment, there is described a case of using a hard disk as an electronic unit. Even in a case of using an optical communication module unit, the same effect can be obtained.

Further, even in a case of using an isolator having projections with a shape other than those in the first and second embodiments, the same effect can be obtained.

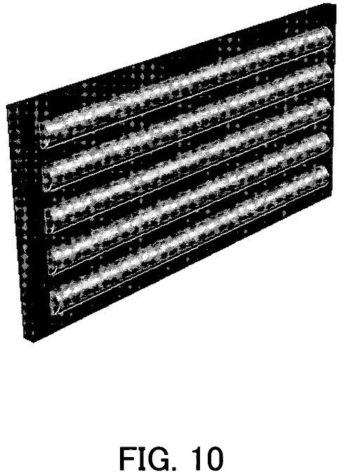

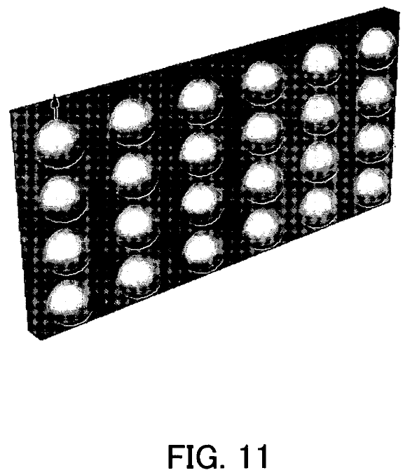

FIG. 10 is a schematic oblique view of a rubber vibration isolator having projections linearly arranged. FIG. 11 is a schematic oblique view of a rubber vibration isolator having projections arranged in the form of points. In addition to the isolators in the first and second embodiments, even when using the isolators having projections as shown in FIGS. 10 and 11, the same effect as those in the first and second embodiments can be obtained.

A third embodiment will be described below by taking a case of FIG. 11 as an example.

Next, the third embodiment will be described.

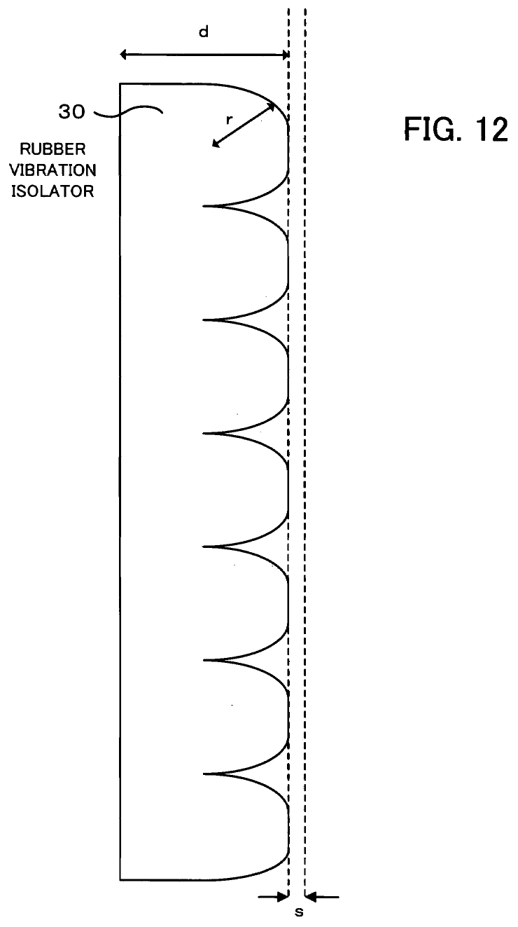

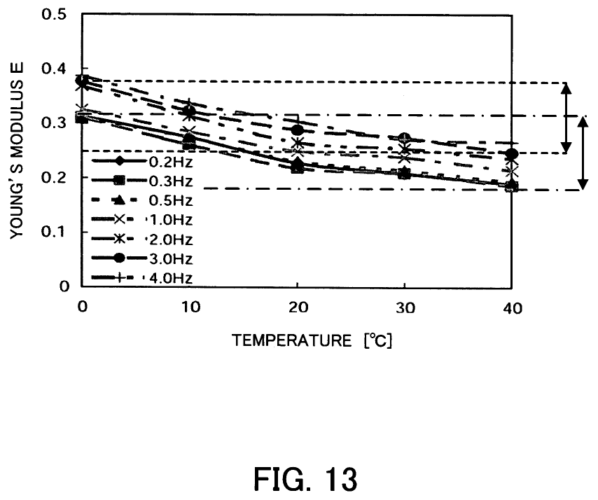

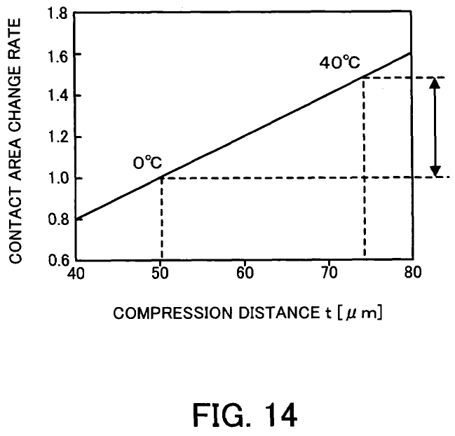

FIG. 12 is a schematic cross-sectional view of an essential part of a rubber vibration isolator according to the third embodiment. FIG. 13 is a graph of temperature dependence of Young's modulus E of a silicone rubber in each frequency of external vibrations and shocks. FIG. 14 is a graph of compression distance dependence of a contact area change rate according to the third embodiment.

In the third embodiment, a rubber vibration isolator 30 as shown in FIG. 12 is made of silicone rubber (thermal expansion coefficient: 2×10⁻⁴/° C.) and is disposed between a hard disk and casing (not shown). Further, the rubber vibration isolator 30 is designed, for example, to a rubber block of which the projection is a hemisphere with a curvature radius r of 1 mm, of which the leading flat portion is at a compression distance s of 50 μm from the peak and which has a thickness d of 3 mm.

When the temperature in the use environment of the rubber vibration isolator 30 changes, for example, from 0 to 40° C., the following events occur. That is, Young's modulus E of the rubber vibration isolator 30 in each frequency of external vibrations and shocks decreases to about two-thirds with temperature changes, as shown in FIG. 13.

On the other hand, the compression distance of the rubber vibration isolator 30 increases by 24 μm as shown in FIG. 14. By the increase in the compression distance, the contact area after the temperature change increases to about one and one-half of the contact area before the temperature change. As a result, since Young's modulus E decreases to about two-thirds and the contact area change rate increases to about one and one-half, the formula (3) is satisfied in the third embodiment.

As described above, in the third embodiment, the rubber vibration isolator 30 has projections. Therefore, the contact area between the projection and the hard disk as well as between the projection and the casing can change depending on the temperature changes in the use environment. Further, the contact area and an inverse number of Young's modulus E of the rubber vibration isolator 30 are made equal in the change rate caused due to temperature change. Therefore, the spring constant k of the isolator 30 can be maintained virtually constant even if the temperature in the use environment changes. As a result, a high-reliability vibration-proof structure for a wide temperature range can be obtained.

In the third embodiment, a description is made by taking as an example a case where the temperature in the use environment changes to a temperature higher than a room temperature. Further, even when the temperature in the use environment changes to a temperature lower than a room temperature, the same effect can be obtained.

When the hard disk and the casing are made of metals, a change rate due to temperature change in a space between the casing and the hard disk, in which the rubber vibration isolator 30 is disposed, has little influence on the third embodiment even if ignored. The reason is that a thermal expansion coefficient of the metal is smaller than that of the isolator 30 by one to two digit order.

Particularly suitable materials for the rubber vibration isolator 30 include silicone rubber (silicone gel), urethane rubber (urethane gel) and ethylene propylene rubber, which are commercially-available as vibration-proof materials. In these materials, molecular arrangement is formed such that in order to elevate a damping factor of external vibrations and shocks, a region having a large loss coefficient η is formed near the center of the operating temperature limit. In addition to the above-described materials, other materials can be formed as materials for the rubber vibration isolator 30 as long as capable of providing the same effect as that of the third embodiment. As shown in FIG. 3, in a region having a large loss coefficient η, the change rate of Young's modulus E due to temperature change is also large and therefore, the effect of the third embodiment can be particularly effectively exerted.

In the third embodiment, there is described a case of using a hard disk as an electronic unit. Even in a case of using an optical communication module unit, the same effect can be obtained.

Further, even in a case of using an isolator having projections with a shape other than those in the first and second embodiments, the same effect can be obtained.

In the present invention, the electronic apparatus comprises a casing for storing an electronic unit which requires vibration isolation; and a rubber vibration isolator having projections on one face or both faces thereof, which is disposed between the electronic unit and the casing such that the projections have contact areas with the unit as well as with the casing and in which the contact area and an inverse number of Young's modulus are equal in the change rate caused due to temperature change. Therefore, the spring constant of the rubber vibration isolator can be maintained virtually constant without depending on the temperature change. As a result, a high-reliability vibration-proof structure for a wide temperature range can be obtained.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. An electronic apparatus having an electronic unit with a vibration-proof structure, comprising:
a casing for storing the electronic unit; and
a vibration control body having projections on one face or both faces thereof, which is disposed between the electronic unit and the casing such that the projections have contact areas with the unit as well as with the casing and in which the contact area and an inverse number of Young's modulus are equal in a change rate caused due to temperature change.

2. The electronic apparatus according to claim 1, wherein the electronic unit is a hard disk.

3. The electronic apparatus according to claim 1, wherein the electronic unit is an optical communication module unit.

4. The electronic apparatus according to claim 1, wherein the vibration control body is made of silicone rubber or silicone gel.

5. The electronic apparatus according to claim 1, wherein the vibration control body is made of urethane rubber or urethane gel.

6. The electronic apparatus according to claim 1, wherein the vibration control body is made of ethylene propylene rubber.

7. The electronic apparatus according to claim 1, wherein the projection of the vibration control body has a shape of a part of an ellipsoid.

8. The electronic apparatus according to claim 1, wherein the projection of the vibration control body has a shape of a hemisphere.

9. The electronic apparatus according to claim 1, wherein the projection of the vibration control body has a conical shape of which the leading portion is cut off.

10. The electronic apparatus according to claim 1, wherein the projection of the vibration control body is a line projection.

11. The electronic apparatus according to claim 1, wherein the projection of the vibration control body is a point projection.
